(19) United States
(12) Patent Application Publication
(10) Pub. No.: US 2024/0032013 A1
(43) Pub. Date: Jan. 25, 2024

(54) TERMINAL, BASE STATION AND COMMUNICATION METHOD

(71) Applicant: NTT DOCOMO, INC., Tokyo (JP)

(72) Inventors: Shinya Kumagai, Chiyoda-ku, Tokyo (JP); Satoshi Nagata, Chiyoda-ku, Tokyo (JP); Qiping Pi, Haidian District, Beijing (CN); Jing Wang, Haidian District, Beijing (CN); Lan Chen, Haidian District, Beijing (CN)

(73) Assignee: NTT DOCOMO, INC., Tokyo (JP)

(21) Appl. No.: 18/265,037

(22) PCT Filed: Jan. 8, 2021
(86) PCT No.: PCT/JP2021/000583

§ 371 Date: Jun. 2, 2023

(51) Int. Cl. H04W 72/11; H04W 72/1273; H04L 1/1812

(52) U.S. Cl. CPC H04W 72/11; H04W 72/1273; H04L 1/1812

(57) ABSTRACT

A terminal includes a reception unit configured to receive, from a base station, a configuration concerning semi persistent scheduling (SPS) and a physical downlink shared channel (PDSCH) according to the SPS; a control unit configured to determine hybrid automatic repeat request acknowledgement (HARQ-ACK) feedback information corresponding to the PDSCH according to the SPS, configure a HARQ-ACK codebook concerning the feedback information, and determine a bit with respect to the feedback information by applying the codebook; and a transmission unit configured to transmit the feedback information to the base station. The control unit is configured to configure the codebook based on the configuration concerning the SPS.

### TECHNICAL FIELD

The present invention relates to a terminal, a base station, and a communication method in a wireless communication system.

### BACKGROUND ART

In the 3rd generation partnership project (3GPP), discussions for a wireless communication scheme (hereinafter referred to as “NR”) called 5G or NR (New Radio) have been performed in order to realize further increase in system volume, further increase in data transmission rate, further reduction in delay in a wireless section, and the like. With regard to 5G, various wireless technologies and network architectures have been discussed in order to satisfy a requirement that a delay in a wireless section be equal to or less than 10 Gbps while achieving a throughput equal to or higher than 1 ms (for example, see Non-Patent Document 1).

In addition, in NR, downlink semi-persistent scheduling (SPS) has been specified in which a resource of a physical downlink shared channel (PDSCH) is configured in a terminal and activation/release is performed in accordance with downlink control information (DCI), thereby enabling low-delay data reception (for example, see Non-Patent Document 2).

In addition, in order for NR to support enhanced industrial internet of things (EIIoT) and ultra-reliable and low latency communication (URLLC), enhancement of feedback from a terminal related to hybrid automatic repeat request Acknowledgement (HARQ-ACK) has been discussed.

### PRIOR ART DOCUMENT

### Non Patent Documents

[Non-Patent Document 1] 3GPP TS 38.213 V16. 3.0 (2020-09)
[Non-Patent Document 2] 3GPP TS 38.331 V16. 2.0 (2020-09)

### SUMMARY OF THE INVENTION

### Problem to be Solved by the Invention

In a case where a PDSCH according to SPS is scheduled for a plurality of downlink (DL) slots, disabling of HARQ-ACK corresponding to reception with respect to the PDSCH depending on conditions has been discussed. However, it is unclear how to configure a HARQ-ACK codebook in a case where a part of the HARQ-ACK transmission is disabled.

The present invention has been made in view of the above points, and an object of the present invention is that a terminal that has received data from a base station transmits feedback information in response to reception of the data to the base station.

### Means for Solving the Problem

According to the disclosed technology, a terminal includes a reception unit configured to receive, from a base station, a configuration concerning semi-persistent scheduling (SPS) and a physical downlink shared channel (PDSCH) according to the SPS; and a control unit configured to determine hybrid automatic repeat request acknowledgement (HARQ-ACK) feedback information corresponding to the PDSCH according to the SPS, configure a HARQ-ACK codebook with respect to the feedback information, and determine a bit with respect to the feedback information by applying the codebook; and a transmission unit configured to transmit the feedback information to the base station. The control unit is configured to configure the codebook based on the configuration concerning the SPS.

### Advantageous Effect of the Invention

According to the disclosed technology, there is provided technology that enables a terminal that has received data from a base station to transmit feedback information in response to reception of the data to the base station.

### BRIEF DESCRIPTION OF DRAWINGS

FIG. 1 is a diagram illustrating a wireless communication system according to an embodiment of the present invention;

FIG. 2 is a diagram illustrating the wireless communication system according to the embodiment of the present invention;

FIG. 3 is a sequence diagram illustrating basic operations of the wireless communication system according to the embodiment of the present invention;

FIG. 4 is a diagram illustrating a first example of configuring a HARQ-ACK codebook;

FIG. 5 is a diagram illustrating a second example of configuring a HARQ-ACK codebook;

FIG. 6 is a diagram illustrating a first example of a HARQ-ACK codebook according to the embodiment of the present invention;

FIG. 7 is a diagram illustrating a second example of a HARQ-ACK codebook according to the embodiment of the present invention;

FIG. 8 is a diagram illustrating a third example of a HARQ-ACK codebook according to the embodiment of the present invention;

FIG. 9 is a diagram illustrating a fourth example of an HARQ-ACK codebook according to the embodiment of the present invention;

FIG. 10 is a diagram illustrating an example of a functional configuration of a base station 10 according to the embodiment of the present invention;

FIG. 11 is a diagram illustrating an example of a functional configuration of a terminal 20 according to the embodiment of the present invention; and

FIG. 12 is a diagram illustrating an example of a hardware configuration of the base station 10 or the terminal 20 according to the embodiment of the present invention.

### MODE FOR CARRYING OUT THE INVENTION

Hereinafter, the embodiment of the present invention will be described with reference to the drawings. It should be noted that the embodiment described below is merely an example, and embodiments to which the present invention is applied are not limited to the following embodiment.

In operations of a wireless communication system according to the embodiment of the present invention, an existing technique is appropriately used. The existing technology is, for example, the existing LTE, but is not limited to the existing LTE. In addition, it is assumed that the term “LTE” used in the present specification has a broad meaning to mean any one of LIE-Advanced and schemes after the LIE-Advanced (for example, NR) unless otherwise specified.

In addition, in the embodiment of the present invention described below, terms used in legacy LTE such as synchronization signal (SS), primary SS (PSS), secondary SS (SSS), physical broadcast channel (PBCH), physical random access channel (PRACH), physical downlink control channel (PDCCH), physical downlink shared channel (PDSCH), physical uplink control channel (PUCCH), physical uplink shared channel (PUSCH), and the like are used. This is for convenience of explanation, and signals, functions, and the like similar to these may be referred to by other names. Also, the above terms with respect to NR correspond to NR-SS, NR-PSS, NR-SSS, NR-PBCH, NR-PRACH, etc. However, even a signal used for NR is not necessarily specified as “NR-”.

Further, in the embodiment of the present invention, the duplex scheme may be a time division duplex (TDD) scheme, a frequency division duplex (FDD) scheme, or another scheme (for example, a flexible duplex scheme).

In addition, in the embodiment of the present invention, “configuring” a radio parameter or the like may mean pre-configuring a predetermined value or configuring a radio parameter indicated by a base station 10 or a terminal 20.

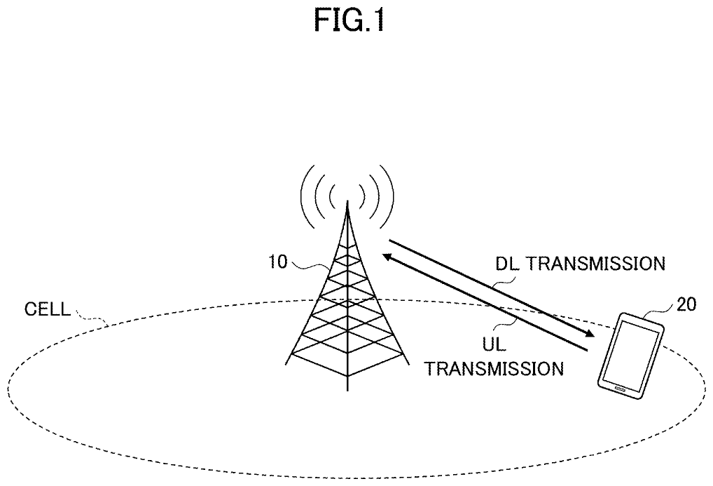

FIG. 1 is a diagram illustrating a wireless communication system according to the embodiment of the present invention. As depicted in FIG. 1, the radio communication system according to the embodiment of the present invention includes the base station 10 and the terminal 20. Although the single base station 10 and the single terminal 20 are depicted in FIG. 1, this is merely an example, and a plurality of base stations 10 and a plurality of terminals 20 may be provided.

The base station 10 is a communication apparatus that provides one or more cells and performs wireless communication with the terminal 20. A physical resource of a radio signal is defined with respect to the time domain and with respect to the frequency domain, and the time domain is defined by the number of orthogonal frequency division multiplexing (OFDM) symbols; and the frequency domain may be defined by the number of subcarriers or the number of resource blocks. In addition, a transmission time interval (TTI) with respect to the time domain may be a slot or a sub-slot; or the TTI may be a subframe.

The base station 10 is capable of performing carrier aggregation in which a plurality of cells (a plurality of component carriers (CCs)) are aggregated to perform communication with the terminal 20. In carrier aggregation, one primary cell (PCell) and one or more secondary cells (SCells) are used.

The base station 10 transmits a synchronization signal, system information, and the like to the terminal 20. The synchronization signal is, for example, a NR-PSS or a NR-SSS. The system information is transmitted through, for example, a NR-PBCH or a PDSCH, and is also referred to as broadcast information. As depicted in FIG. 1, the base station 10 transmits a control signal or data to the terminal 20 through a downlink (DL), and receives a control signal or data from the terminal 20 through an uplink (UL). Here, what is transmitted through a control channel such as a PUCCH or a PDCCH is referred to as a control signal, and what is transmitted through a shared channel such as a PUSCH or a PDSCH is referred to as data. However, such a way of naming is merely an example.

The terminal 20 is a communication apparatus having a wireless communication function such as a smartphone, a mobile phone, a tablet, a wearable terminal, or a machine-to-machine (M2M) communication module. As depicted in FIG. 1, the terminal 20 uses various communication services provided by the radio communication system by receiving a control signal or data from the base station 10 through the DL and transmitting a control signal or data to the base station 10 through the UL. Note that the terminal 20 may be referred to as a UE and the base station 10 may be referred to as a gNB.

The terminal 20 is capable of performing carrier aggregation in which a plurality of cells (a plurality of CCs) are aggregated for performing communication with the base station 10. In carrier aggregation, one primary cell and one or more secondary cells are used. Also, a PUCCH-SCell using a PUCCH may be used.

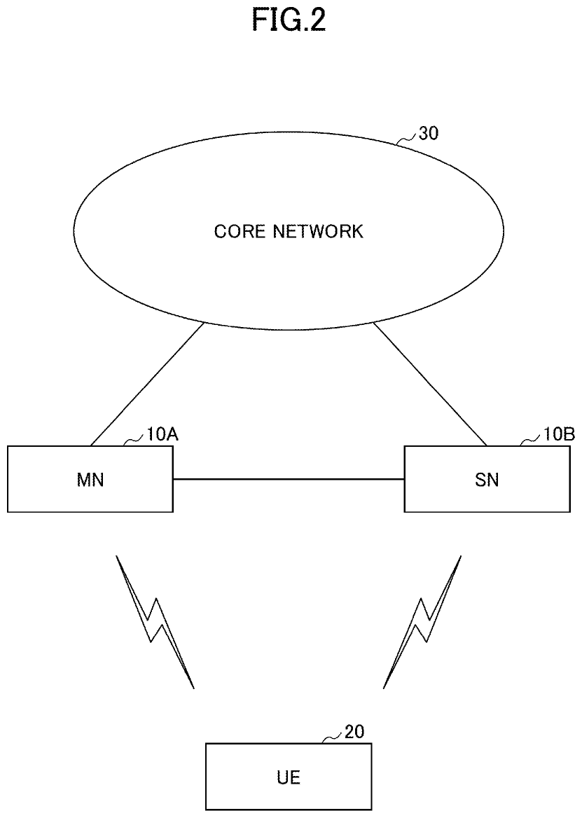

FIG. 2 depicts a configuration example of the radio communication system in a case where dual connectivity (DC) is implemented. As depicted in FIG. 2, a base station 10A serving as master node (MN) and a base station 10B serving as a secondary node (SN) are provided. The base stations 10A and 10B are each connected to a core network. The terminal 20 can communicate with both the base stations 10A and 10B.

A cell group provided by the base station 10A that is the MN is referred to as a master cell group (MCG), and a cell group provided by the base station 10B that is the SN is referred to as a secondary cell group (SCG). At a time of DC, the MCG includes one PCell and one or more SCells, and the SCG includes one primary SCG cell (PSCell) and one or more SCells.

Processing operations in the present embodiment may be executed by the system configuration depicted in FIG. 1, may be executed by the system configuration depicted in FIG. 2, or may be executed by a system configuration other than these.

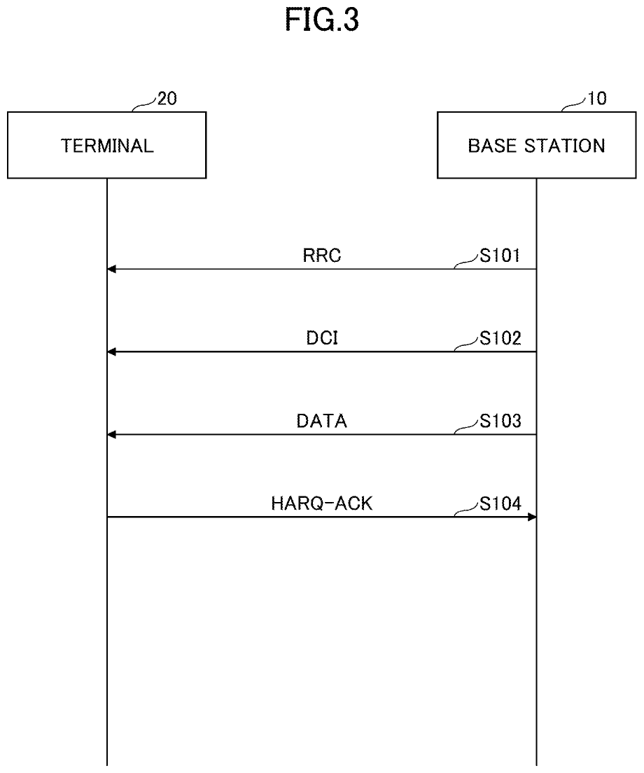

An example of basic operations of the communication system according to the embodiment of the present invention will now be described with reference to FIG. 3. These operations are basically common to the embodiments to be described later.

In S101, the base station 10 transmits downlink SPS configuration information, PUCCH resource configuration information, slot format configuration information, and the like to the terminal 20 through RRC signaling, and the terminal 20 receives these sorts of configuration information. Because the present embodiment is directed to downlink SPS, “SPS” hereinafter means downlink SPS.

The slot format configuration information is, for example, tdd-UL-DL-ConfigurationCommon or tdd-UL-DL-ConfigurationDedicated, and, in accordance with this configuration information, it is configured whether the TDD configuration in each symbol of each slot of one or more slots is of DL, UL, or flexible. Hereinafter, this configuration information is referred to as semi-static TDD configuration information. In addition, flexible may be written as F. Basically, the terminal 20 determines the DL/UL/F of each symbol in each slot in accordance with the semi-static TDD configuration information.

In addition, as the configuration information in S101, a plurality of candidates of a slot format for enabling dynamic switching of a slot format may be indicated. This configuration information is, for example, SlotFormatCombinationsPerCell. Because this information includes an ID of a slot format (SF), it is hereinafter referred to as SFI configuration information.

The terminal 20 receives DCI for activating configuring SPS from the base station 10 in S102, and receives data using a PDSCH resource according to the SPS configuration in S103. In S104, the terminal 20 transmits SPS HARQ-ACK to the base station 10 using the PUCCH resource (may be the PUSCH resource instead in a case where there is UL scheduling) of a slot at a time position specified by the DCI. Hereinafter, HARQ-ACK corresponding to data reception using one or more PDSCH resources according to the SPS configuration is referred to as “SPS HARQ-ACK”. Hereinafter, SPS HARQ-ACK may be referred to as HARQ-ACK. Also, HARQ-ACK may be referred to as HARQ information, HARQ response, feedback information, etc.

The terminal 20 may receive DCI that dynamically specifies a slot format from the base station 10 in S102 or before or after S102. The DCI is control information for specifying an ID to be actually used among IDs of a plurality of slot formats configured by the SFI configuration information. When a slot format is specified by the DCI, the terminal 20 determines DL/UL/F of each symbol of each slot in accordance with the slot format instead of the semi-static TDD configuration information. Information of the DCI is referred to as dynamic SFI specifying information (or dynamic SFI, or SFI).

In order for NR to support enhanced industrial internet of things (EIIoT) and ultra-reliable and low latency communication (URLLC), enhancement of feedback from a terminal concerning hybrid automatic repeat request acknowledgement (HARQ-ACK) has been discussed.

As enhancement of feedback from a terminal, in order to reduce a HARQ-ACK payload size concerning SPS, it has been discussed to disable or skip HARQ-ACK with respect to a predetermined SPS configuration. For example, disabling or skipping may be configured through higher layer signaling for each SPS configuration. In this regard, it is necessary to specify operations in a case of skipping HARQ-ACK with respect to a HARQ-ACK codebook type 1.

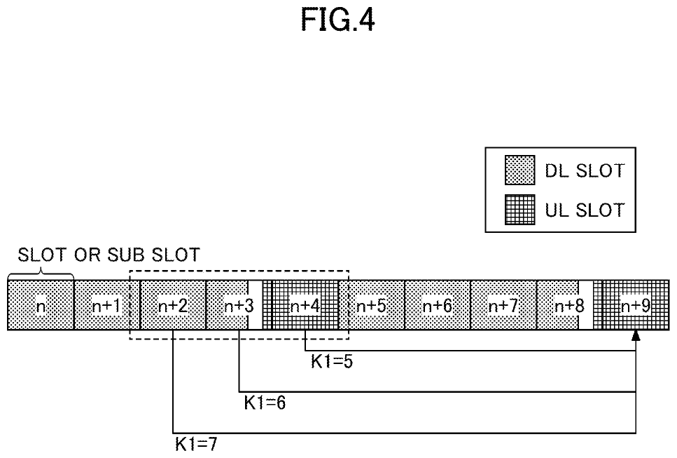

FIG. 4 depicts a first example of configuring a HARQ-ACK codebook type 1. An example of generating a HARQ-ACK codebook type 1 will now be described with reference to FIG. 4.

As a first process, a HARQ-ACK occasion for a candidate PDSCH reception is determined. For a serving cell c for which active DL-BWP or active UL-BWP is configured, the terminal 20 determines a HARQ-ACK occasion for a candidate PDSCH reception. The terminal 20 determines a HARQ-ACK window size based on a HARQ-ACK timing value K1. FIG. 4 depicts an example in which K1 is 5, 6, or 7. In FIG. 4, slot #n+2, slot #n+3, and slot #n+4 surrounded by a broken line indicate a HARQ-ACK window. A slot may be replaced with a sub-slot.

As a second process, for each K1, candidates for a PDSCH reception occasion are determined in each slot. Candidates for a PDSCH reception occasion are associated with a set R in a resource allocation table with respect to the time domain. Further, a candidate for a PDSCH reception occasion in a resource allocation table with respect to the time domain overlapping with UL that is configured by a parameter TDD-UL-DL-ConfigurationCommon or a parameter TDD-UL-DL-ConfigDedicated is excluded. Further, when candidates for a PDSCH reception occasion overlap with each other with respect to the time domain, the candidates for the PDSCH reception occasion are generated based on a predetermined rule.

As a third process, the terminal 20 determines HARQ-ACK information bits, wherein the total number of the bits is O^{ACK}. The terminal 20 reports HARQ-ACK information corresponding to PDSCH reception or SPS PDSCH release using a HARQ-ACK codebook with respect to a slot indicated by a value at a PDSCH-to-HARQ feedback timing indicator field of a corresponding DCI format. The terminal 20 reports HARQ-ACK information as NACK in accordance with a HARQ-ACK codebook with respect to a slot that has not been indicated by the value at the PDSCH-to-HARQ feedback timing indicator field of the corresponding DCI format.

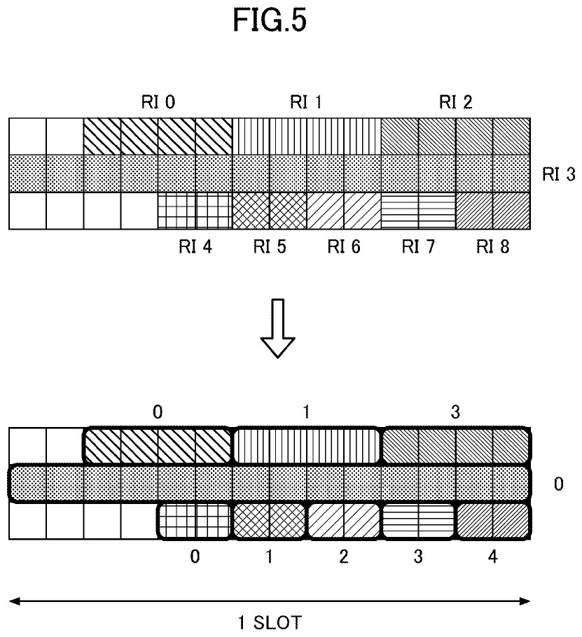

FIG. 5 depicts a second example of configuring an HARQ-ACK codebook. FIG. 5 is a diagram schematically illustrating candidate PDSCH receptions with respect to the time domain, and depicts an example of determining a HARQ-ACK occasion. As depicted in FIG. 5, resource ID (RI) 0 to resource ID 8 are configured as candidate PDSCH receptions.

In the example depicted in FIG. 5, 5 bits are allocated for HARQ-ACK. A HARQ-ACK bit #0 corresponds to a resource ID 0, a resource ID 3, or a resource ID 4. A HARQ-ACK bit #1 corresponds to a resource ID 1 or a resource ID 5. A HARQ-ACK bit #2 corresponds to a resource ID 6. A HARQ-ACK bit #3 corresponds to a resource ID 2 or a resource ID 7. A HARQ-ACK bit #4 corresponds to a resource ID 8.

In addition, in a case where the terminal 20 reports HARQ-ACK for only SPS-PDSCH reception through a PUCCH, the terminal 20 may determine a HARQ-ACK codebook only for one SPS-PDSCH reception based on a corresponding HARQ-ACK occasion, or may determine a HARQ-ACK codebook for HARQ-ACK information for more than one SPS-PDSCH reception.

Note that, in a case where, with respect to a serving cell c, the terminal 20 is configured to receive an SPS-PDSCH from a slot n_{D}−N_{PDSCH}^{repeat}+1 to a slot n_{D} with respect to an SPS-PDSCH configuration s, the terminal 20 may exclude an SPS-PDSCH with respect to a slot for which reception is not requested, and may exclude an SPS-PDSCH with respect to a slot for which reception is not requested due to an overlap according to a TDD-UL-DL configuration. The number of repetitions N_{PDSCH}^{repeat} may be determined in accordance with pdsch-AggregationFactor included in an information element sps-Config or pdsch-Config.

The HARQ-ACK bits may be sorted with respect to DL slots in ascending order, may be sorted with respect to SPS configuration indexes in ascending order in each DL slot, or may be sorted with respect to serving cell indexes in ascending order in each SPS configuration index.

Note that, in a case where a PDSCH according to dynamic grant overrides an SPS-PDSCH, the terminal 20 need not assume to decode a PDSCH scheduled by a PDCCH scrambled by C-RNTI, CS-RNTI, or MCS-C-RNTI, with respect to a serving cell. Except for a case where a PDSCH scheduled by a PDCCH ends at least 14 symbols before a first symbol at which the PDSCH not accompanied by PDCCH transmission starts, the terminal 20 may receive one or more PDSCHs not accompanied by PDCCH transmission and having a partial or entire overlap with respect to the time domain, with respect to the same serving cell. In a case where the terminal 20 decodes a PDSCH scheduled by a PDCCH, a corresponding symbol period may be determined based on the smallest numerology between the scheduling PDCCH and the PDSCH.

In a case where an SPS-PDSCH has an overlap, in a case where the terminal 20 receives, in a certain slot with respect to a certain serving cell, a plurality of PDSCHs, each of which is not accompanied by PDCCH transmission, after resolving the overlap with a UL symbol according to a TDD-UL-DL configuration, the terminal 20 may receive PDSCHs in accordance with steps 0-3 described below.
Step 0): the number of selected PDSCHs to be decoded is configured as j=0, and a set of PDSCHs not accompanied by PDCCH transmission in a slot is referred to as Q.
Step 1): the PDSCH with the smallest sps-ConfigIndex from among those in the Q is received, and an increment of j=j+1 is performed.
Step 2): the PDSCH that has been received in step 1), and another PDSCH having a partial or entire overlap with the PDSCH that has been received in step 1) are removed from the Q.
Step 3): steps 1 and 2 are repeated until the Q becomes empty or j becomes equal to the number of unicast PDSCHs with respect to the slot supported by the terminal 20.

Here, in a case where HARQ-ACK feedback disabling is configured with respect to a predetermined SPS configuration, one candidate PDSCH reception may correspond to a plurality of start and length indicator values (SLIV) with respect to a HARQ-ACK codebook type 1. Therefore, when generating a HARQ-ACK bit, it is necessary to determine when and how to skip HARQ-ACK corresponding to a predetermined SPS configuration. In addition, also with respect to a HARQ-ACK codebook type 2 and a HARQ-ACK codebook type 3, it is necessary to determine whether or not to perform disabling of HARQ-ACK corresponding to a predetermined SPS configuration.

Thus, in a case where a HARQ-ACK bit corresponding to an SPS configuration is disabled, the HARQ-ACK bit may be skipped when a HARQ-ACK codebook type 1 is generated. In a case where the terminal 20 is to report only HARQ-ACK information concerning the SPS-PDSCH reception, this skipping may be applied. The HARQ-ACK bit may be generated based on an SPS configuration index, a serving cell index, and a DL slot index. Similarly, in a case where a HARQ-ACK bit corresponding to an SPS configuration is disabled, the HARQ-ACK bit may be skipped when a HARQ-ACK codebook type 2 is generated. In addition, when a HARQ-ACK codebook type 2 is generated, in a case where the terminal 20 is to report HARQ-ACK information concerning the SPS-PDSCH reception together with HARQ-ACK information according to PDSCH according to dynamic grant or SPS release, this skipping may be applied.

In addition, regardless of a HARQ-ACK codebook type 1 or a HARQ-ACK codebook type 2, in a case where the terminal 20 is to report both HARQ-ACK information concerning the SPS-PDSCH reception and HARQ-ACK information according to PDSCH according to dynamic grant or SPS release, the above-mentioned skipping may be applied. Further, a configuration concerning SPS may include information indicating to disable HARQ-ACK feedback corresponding to an SPS-PDSCH.

In addition, in a case where the terminal 20 is to report both HARQ-ACK information concerning the SPS-PDSCH reception and HARQ-ACK information according to PDSCH according to dynamic grant or SPS release, disabling HARQ-ACK concerning the SPS-PDSCH reception need not be applied to generation of a HARQ-ACK codebook type 1.

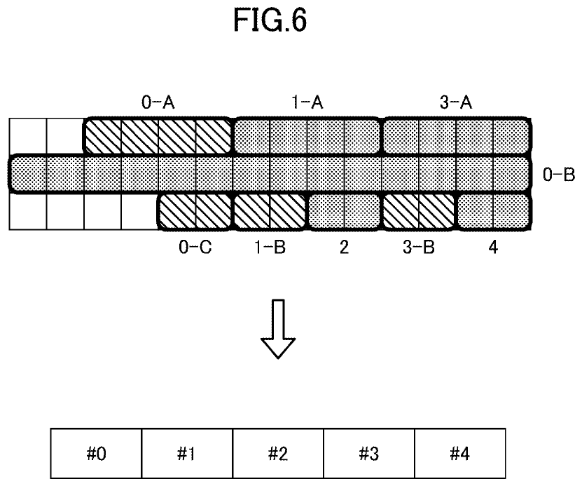

FIG. 6 is a diagram illustrating a first example of a HARQ-ACK codebook according to the embodiment of the present invention. In FIG. 6, it is assumed that 0-A denotes a SPS-PDSCH corresponding to a SPS configuration index #0, 0-C denotes a SPS-PDSCH corresponding to a SPS configuration index #1, 1-B denotes a SPS-PDSCH corresponding to a SPS configuration index #2, and 3-B denotes a SPS-PDSCH corresponding to a SPS configuration index #0. As depicted in FIG. 6, 5-bit HARQ-ACK information may be generated for five candidate PDSCH receptions, without executing disabling of HARQ-ACK concerning the SPS-PDSCH reception.

As another example, in a case where a candidate PDSCH reception includes at least one SLIV corresponding to the SPS-PDSCH reception and disabling HARQ-ACK feedback is configured for an SPS-PDSCH (in the case of multiple SPS-PDSCHs, the SPS-PDSCH corresponding to the lowest SPS configuration index), a HARQ-ACK bit of a candidate PDSCH reception corresponding to the SPS-PDSCH may be skipped.

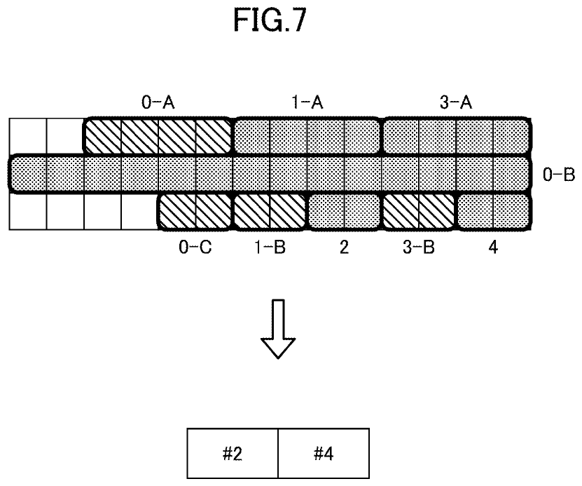

FIG. 7 is a diagram illustrating a second example of an HARQ-ACK codebook according to the embodiment of the present invention. In FIG. 7, it is assumed that 0-A denotes an SPS-PDSCH corresponding to an SPS configuration index #0, 0-C denotes an SPS-PDSCH corresponding to an SPS configuration index #1, 1-B denotes an SPS-PDSCH corresponding to an SPS configuration index #2, and 3-B denotes an SPS-PDSCH corresponding to an SPS configuration index #0. Further, FIG. 7 depicts an example in which HARQ-ACK feedback is disabled for SPS configuration indexes #0, #2, and #3.

Because 0-A denotes the SPS-PDSCH corresponding to the SPS configuration index #0 and HARQ-ACK corresponding to the SPS configuration index #0 is disabled, a HARQ-ACK bit #0 corresponding to 0-A is skipped. Because 1-B denotes the SPS-PDSCH corresponding to the SPS configuration index #2 and HARQ-ACK corresponding to the SPS configuration index #2 is disabled, a HARQ-ACK bit #1 corresponding to 1-B is skipped. Because 3-B denotes the SPS-PDSCH corresponding to the SPS configuration index #3 and HARQ-ACK corresponding to the SPS configuration index #3 is disabled, a HARQ-ACK bit #3 corresponding to 3-B is skipped. Therefore, as depicted in FIG. 7, HARQ-ACK bits #2 and #4 are generated as a HARQ-ACK codebook type 1.

As another example, a condition for skipping a candidate PDSCH reception may be configured. For example, in a case where the terminal 20 does not detect DCI that overrides an SPS-PDSCH and ends at least 14 symbols before the SPS-PDSCH, a HARQ-ACK bit corresponding to the SPS-PDSCH may be skipped.

For example, in FIG. 7, it is assumed that 0-A denotes an SPS-PDSCH corresponding to an SPS configuration index #0, 0-C denotes an SPS-PDSCH corresponding to an SPS configuration index #1, 1-B denotes an SPS-PDSCH corresponding to an SPS configuration index #2, and 3-B denotes an SPS-PDSCH corresponding to an SPS configuration index #0. Furthermore, it is assumed that HARQ-ACK feedback is disabled for the SPS configuration indexes #0, #2, and

Because 0-A denotes the SPS-PDSCH corresponding to the SPS configuration index #0 and HARQ-ACK corresponding to the SPS configuration index #0 is disabled, a HARQ-ACK bit #0 corresponding to 0-A is skipped. Because 1-B denotes the SPS-PDSCH corresponding to the SPS configuration index #2 and HARQ-ACK corresponding to the SPS configuration index #2 is disabled, a HARQ-ACK bit #1 corresponding to 1-B is skipped. Because 3-B denotes the SPS-PDSCH corresponding to the SPS configuration index #3 and HARQ-ACK corresponding to the SPS configuration index #3 is disabled, a HARQ-ACK bit #3 corresponding to 3-B is skipped. Therefore, as depicted in FIG. 7, HARQ-ACK bits #2 and #4 are generated as a HARQ-ACK codebook type 1.

In addition, for example, as another condition, in a case where the terminal 20 detects DCI that schedules a dynamic grant (DG)-PDSCH that overrides an SPS-PDSCH before at least 14 symbols before from the SPS-PDSCH, the terminal 20 may operate in accordance with 1) or 2) described below.
1) In a case where a HARQ-ACK bit corresponding to the scheduled DG-PDSCH is the same bit as candidate PDSCH reception corresponding to an SPS-PDSCH, a HARQ-ACK bit corresponding to the candidate PDSCH reception may be generated based on a decoding result.
2) In a case where a HARQ-ACK bit corresponding to the scheduled DG-PDSCH is not the same HARQ-ACK bit as candidate PDSCH reception corresponding to an SPS-PDSCH, a HARQ-ACK bit corresponding to the candidate PDSCH reception may be skipped.

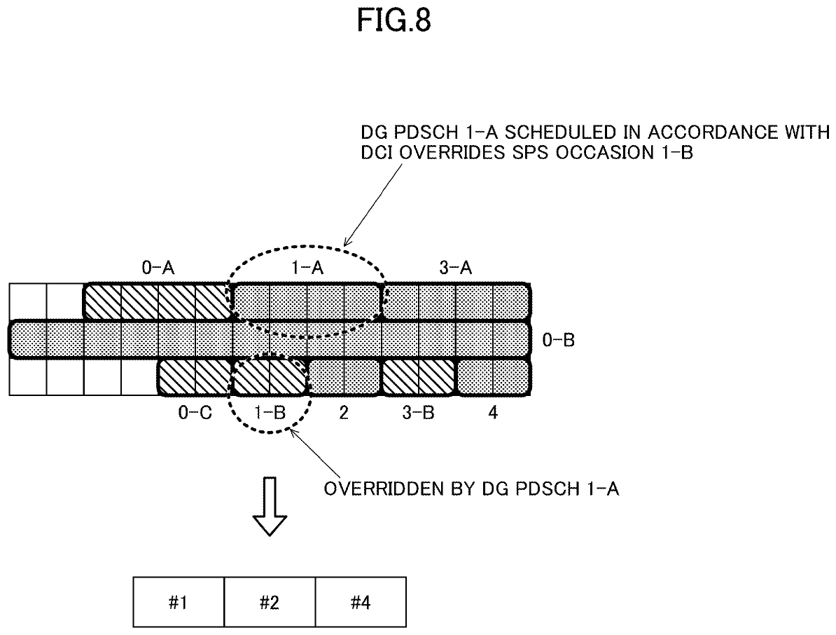

FIG. 8 is a diagram illustrating a third example of a HARQ-ACK codebook according to the embodiment of the present invention. In FIG. 8, it is assumed that 0-A denotes an SPS-PDSCH corresponding to an SPS configuration index #0, 0-C denotes an SPS-PDSCH corresponding to an SPS configuration index #1, 1-B denotes an SPS-PDSCH corresponding to an SPS configuration index #2, and 3-B denotes an SPS-PDSCH corresponding to an SPS configuration index #0. Furthermore, it is assumed that HARQ-ACK feedback is disabled for SPS configuration indexes #0, #2, and #3.

In FIG. 8, it is assumed that the terminal 20 detects DCI that schedules 1-A which denotes a DG-PDSCH. It is assumed that the DCI ends at least 14 symbols before the beginning of 1-B.

As depicted in FIG. 8, 1-A which denotes the DG-PDSCH overrides 1-B that is the SPS-PDSCH. Because 0-A denotes the SPS-PDSCH corresponding to the SPS configuration index #0 and HARQ-ACK corresponding to the SPS configuration index #0 is disabled, a HARQ-ACK bit #0 corresponding to 0-A is skipped. A HARQ-ACK bit #1 is generated to correspond to 1-A which denotes the DG-PDSCH. Because 3-B denotes the SPS-PDSCH corresponding to the SPS configuration index #3 and HARQ-ACK corresponding to the SPS configuration index #3 is disabled, a HARQ-ACK bit #3 corresponding to 3-B is skipped. Therefore, as depicted in FIG. 8, HARQ-ACK bits #1, #2 and #4 are generated as a HARQ-ACK codebook type 1.

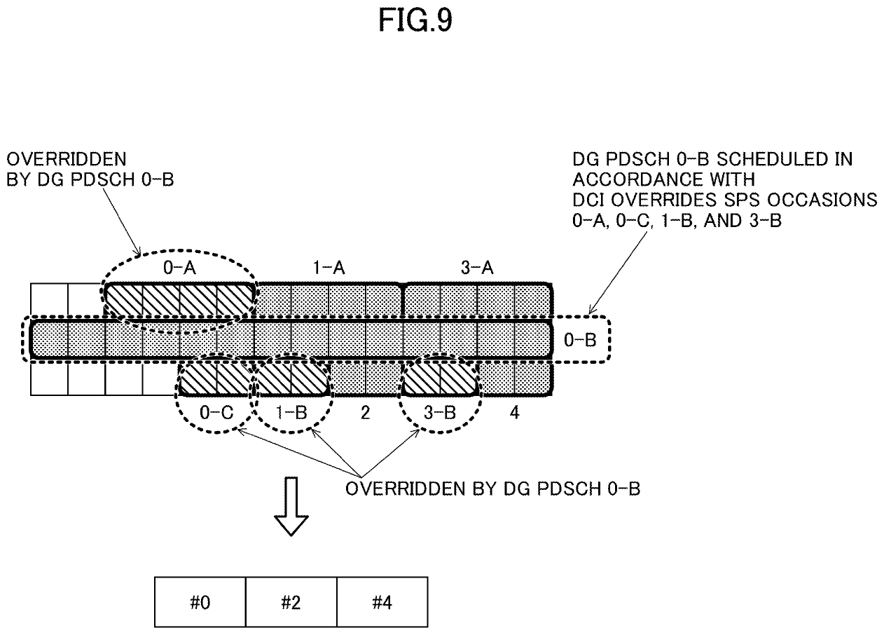

FIG. 9 is a diagram illustrating a fourth example of a HARQ-ACK codebook according to the embodiment of the present invention. In FIG. 9, it is assumed that 0-A denotes an SPS-PDSCH corresponding to an SPS configuration index #0, 0-C denotes an SPS-PDSCH corresponding to an SPS configuration index #1, 1-B denotes an SPS-PDSCH corresponding to an SPS configuration index #2, and 3-B denotes an SPS-PDSCH corresponding to an SPS configuration index #0. Furthermore, it is assumed that HARQ-ACK feedback is disabled for SPS configuration indexes #0, #2, and #3.

In FIG. 9, it is assumed that the terminal 20 detects DCI that schedules 0-B which is a DG-PDSCH. It is assumed that the DCI ends at least 14 symbols before the beginning of 0-A.

As depicted in FIG. 9, 0-B which denotes a DG-PDSCH overrides 0-A, 0-C, 1-B, and 3-B which denote SPS-PDSCHs. A HARQ-ACK bit #0 is generated to correspond to 0-B which denotes the DG-PDSCH. With respect to a HARQ-ACK bit #1, the HARQ-ACK bit #1 is skipped because 0-B which denotes the DG-PDSCH overrides 1-B which denotes the SPS-PDSCH and the HARQ-ACK bit #1 does not correspond to 0-B. With respect to a HARQ-ACK bit #3, the HARQ-ACK bit #3 is skipped because 0-B which denotes the DG-PDSCH overrides 3-B which denotes the SPS-PDSCH and the HARQ-ACK bit #1 does not correspond to 3-B. Therefore, as depicted in FIG. 8, HARQ-ACK bits #0, #2, and #4 are generated as a HARQ-ACK codebook type 1. Through the operations described above, the influence of the skipped HARQ-ACK bits is thus avoided accordingly, and it is possible to generate the HARQ-ACK bit with respect to the DG-PDSCH.

With regard to a HARQ-ACK codebook type 2 (which may be of enhanced type 2 (e-Type 2)), HARQ-ACK with respect to an SPS-PDSCH concerning an SPS configuration including a configuration that disables HARQ-ACK reporting may be reported or need not be reported.

For example, disabling of HARQ-ACK concerning an SPS-PDSCH need not be applied to a HARQ-ACK codebook type 2. In addition, for example, HARQ-ACK disabled in accordance with an SPS configuration need not be included in the HARQ-ACK codebook type 2 and may be included in an above-described HARQ-ACK codebook type 1. Accordingly, a payload with respect to the HARQ-ACK codebook type 2 can be reduced.

With regard to a HARQ-ACK codebook type 3, HARQ-ACK with respect to an SPS-PDSCH concerning an SPS configuration including a configuration of disabling HARQ-ACK reporting may be reported or need not be reported.

For example, disabling of HARQ-ACK concerning an SPS-PDSCH need not be applied to a HARQ-ACK codebook type 3. That is, HARQ-ACK concerning all HARQ process IDs with respect to all serving cells may be reported regardless of whether or not the HARQ process IDs correspond to an SPS configuration in which HARQ-ACK feedback is configured to be disabled.

Also, for example, HARQ-ACK disabled in accordance with an SPS configuration need not be included in a HARQ-ACK codebook type 3. That is, a HARQ process ID corresponding to the SPS configuration in which HARQ-ACK feedback is configured to be disabled may be skipped when the HARQ-ACK codebook type 3 is generated. Accordingly, a payload of the HARQ-ACK codebook type 3 can be reduced.

Note that a UE capability may be defined that indicates whether or not to support an SPS configuration that disables HARQ-ACK reporting.

In the above-described embodiment, which process or method is to be used may be predetermined using a higher layer parameter, may be predetermined based on a UE capability reported by the terminal 20, may be predefined as a specification, or may be predetermined based on a higher layer parameter and a UE capability.

According to the above embodiment, the terminal 20 can configure a HARQ-ACK codebook corresponding to partially disabled or skipped SPS-HARQ-ACK and transmit HARQ-ACK feedback information to the base station 10.

That is, the terminal having received data from the base station can transmit feedback information corresponding to reception of the data to the base station.

### (Apparatus Configuration)

Next, functional configuration examples of the base station 10 and the terminal 20 that execute the processes and operations described above will be described. The base station 10 and the terminal 20 include functions for executing the above-described embodiment; each of the base station 10 and the terminal 20 may have only some of the functions of the embodiment.

### <Base Station 10>

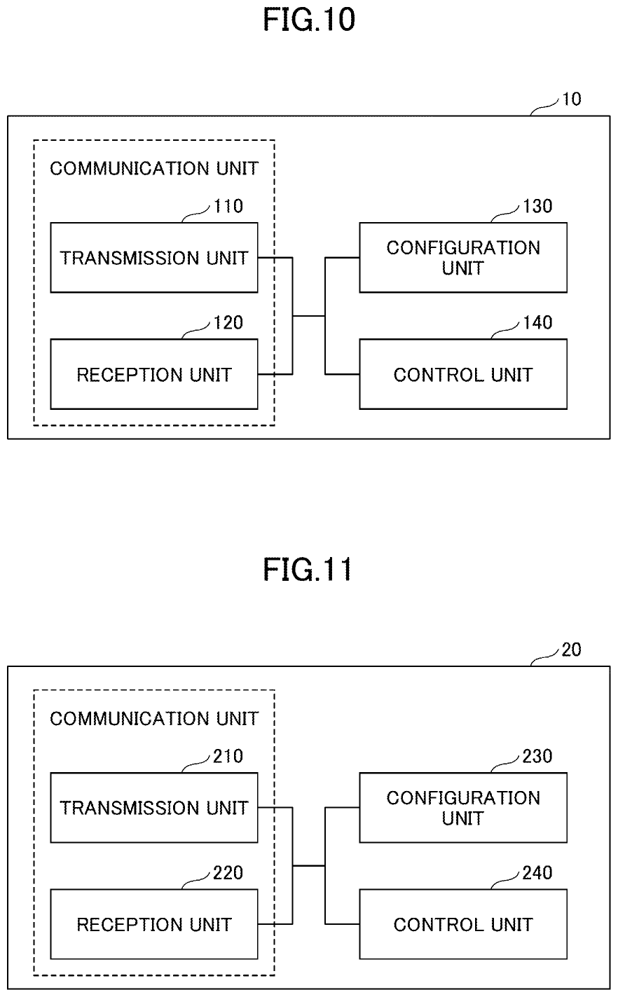

FIG. 10 is a diagram illustrating an example of a functional configuration of the base station 10. As depicted in FIG. 10, the base station 10 includes a transmission unit 110, a reception unit 120, a configuration unit 130, and a control unit 140. The functional configuration depicted in FIG. 10 is merely an example. As long as the operations according to the embodiment of the present invention can be executed, the segmentation into the functional units and the names of the functional units may be changed freely. The transmission unit 110 and the reception unit 120 may be referred to as a communication unit.

The transmission unit 110 has a function of generating a signal to be transmitted to the terminal 20 and wirelessly transmitting the signal. The reception unit 120 includes a function of receiving various signals transmitted from the terminal 20 and acquiring, for example, information of higher layers from the received signals. Also, the transmission unit 110 has a function of transmitting NR-PSS, NR-SSS, NR-PBCH, DL/UL control signals, DL data, and the like to the terminal 20. The transmission unit 110 transmits configuration information and the like described in the embodiment.

The configuration unit 130 stores configuration information that is set in advance and various kinds of configuration information to be transmitted to the terminal 20 in the storage device, and reads the configuration information from a storage device as necessary. The control unit 140 performs, for example, resource allocation, overall control of the base station 10, and the like. It should be noted that a functional unit for signal transmission in the control unit 140 may be included in the transmission unit 110, and a functional unit for signal reception in the control unit 140 may be included in the reception unit 120. The transmission unit 110 and the reception unit 120 may be referred to as a transmitter and a receiver, respectively.

### <Terminal 20>

FIG. 11 is a diagram illustrating an example of a functional configuration of the terminal 20. As depicted in FIG. 11, the terminal 20 includes a transmission unit 210, a reception unit 220, a configuration unit 230, and a control unit 240. The functional configuration depicted in FIG. 11 is merely an example. As long as the operations according to the embodiment of the present invention can be executed, segmentation into the functional units and the names of the functional units may be changed freely. The transmission unit 210 and the reception unit 220 may be referred to as a communication unit.

The transmission unit 210 generates a transmission signal from transmission data and wirelessly transmits a transmission signal. The reception unit 220 wirelessly receives various signals and acquires signals of higher layers from the physical layers of the received signals. Further, the transmission unit 210 transmits HARQ-ACK, and the reception unit 220 receives the configuration information and the like described in the embodiment.

The configuration unit 230 stores various types of configuration information received from the base station 10 by the reception unit 220 in a storage device, and reads the configuration information from the storage device as necessary. The configuration unit 230 also stores configuration information that is set in advance. The control unit 240 performs overall control of the terminal 20. It should be noted that a functional unit for signal transmission in the control unit 240 may be included in the transmission unit 210, and a functional unit for signal reception in the control unit 240 may be included in the reception unit 220. The transmission unit 210 and the reception unit 220 may be referred to as a transmitter and a receiver, respectively.

### (Hardware Configuration)

The block diagrams (FIGS. 10 and 11) used in the description of the above-described embodiment depict blocks of the functional units. These functional blocks (configuration units) are each implemented by a combination of at least one of hardware or software. In addition, a specific method of implementing the functional blocks is not particularly limited. That is, each functional block may be implemented by using one physically or logically coupled device, or may be implemented by directly or indirectly (for example, using a wire, a wireless way, or the like) coupled two or more physically or logically separated plurality of devices. The functional blocks may be implemented by combining software with the above-mentioned one device or plurality of devices.

Each function may be, but are not limited to, determining, deciding, judging, calculating, computing, processing, deriving, investigating, searching, ascertaining, receiving, transmitting, outputting, accessing, resolving, selecting, choosing, establishing, comparing, assuming, expecting, deeming, broadcasting, notifying, communicating, forwarding, configuring, reconfiguring, allocating, mapping, assigning, or the like. For example, a functional block that has a function of transmission is referred to as a transmitting unit or a transmitter. In either case, as described above, the specific implementation method is not particularly limited.

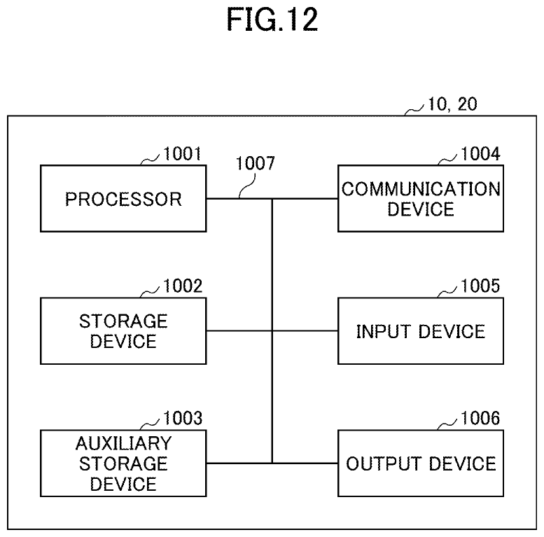

For example, the base station 10, the terminal 20, and the like according to the embodiment of the present disclosure may function as computers that perform processing of the wireless communication methods according to the present disclosure. FIG. 12 is a diagram illustrating an example of a hardware configuration of each of the base station 10 and the terminal 20 according to the embodiment of the present disclosure. The base station 10 and the terminal 20 described above may be physically configured as computer apparatuses each including a processor 1001, a storage device 1002, an auxiliary storage device 1003, a communication device 1004, an input device 1005, an output device 1006, a bus 1007, and the like.

In the following description, the term “apparatus” can be read as a circuit, a device, a unit, or the like. The hardware configurations of the base station 10 and the terminal 20 may be configured to each include one or more of the devices depicted in the figure, or may be configured not to include some of the devices.

Each function in the base station 10 and the terminal 20 is implemented by causing hardware such as the processor 1001 and the storage device 1002 to read predetermined software (program), causing the processor 1001 to perform operations to control communication by the communication device 1004 or to control at least one of reading and writing of data with respect to the storage device 1002 and the auxiliary storage device 1003.

The processor 1001 operates, for example, an operating system to control the entire computer. The processor 1001 may be configured as a central processing unit (CPU) including an interface with respect to a peripheral device, a control device, an arithmetic and logic device, a register, and the like. For example, the above-described control unit 140, control unit 240, and the like may be implemented by the processor 1001.

In addition, the processor 1001 reads out a program (program code), a software module, data, or the like from at least one of the auxiliary storage device 1003 or the communication device 1004 to the storage device 1002, and executes various processes in accordance with the program, the software module, the data, or the like. As the program, a program that causes the computer to execute at least some of the operations described with regard to the above-described embodiment is used. For example, the control unit 140 of the base station 10 depicted in FIG. 10 may be implemented by a control program stored in its storage device 1002 and executed by its processor 1001. In addition, for example, the control unit 240 of the terminal 20 depicted in FIG. 11 may be implemented by a control program stored in its storage device 1002 and executed by its processor 1001. Although it has been described that the above-described various processes are executed by each single processor 1001, the processes may be executed by two or more processors 1001 simultaneously or sequentially. The processor(s) 1001 may be implemented by one or more chips. The program may be transmitted from a network via an electric communication line.

The storage device 1002 is a computer-readable recording medium, and may include at least one of a read-only memory (ROM), an erasable programmable ROM (EPROM), an electrically erasable programmable ROM (EEPROM), a random access memory (RAM), or the like. The storage device 1002 may be referred to as a register, a cache, a main memory (main storage device), or the like. The storage device 1002 can store programs (program codes), software modules, and the like that are executable to implement the communication method according to the embodiment of the present disclosure.

The auxiliary storage device 1003 is a computer-readable recording medium, and may include at least one of an optical disk such as a compact disc ROM (CD-ROM), a hard disk drive, a flexible disk, a magneto-optical disc (for example, a compact disc, a digital versatile disc, or a Blu-ray (registered trademark) disc, a smart card, a flash memory (for example, a card, a stick, or a key drive), a floppy (registered trademark) disk, a magnetic strip, or the like. The aforementioned storage medium may be, for example, a database, a server, or any other appropriate medium including at least one of the storage device 1002 or the auxiliary storage device 1003.

The communication device 1004 is hardware (transmission and reception device) for performing communication between the computers via at least one of a wired network or a wireless network, and is also referred to as a network device, a network controller, a network card, a communication module, or the like, for example. The communication device 1004 may be configured to include a high-frequency switch, a duplexer, a filter, a frequency synthesizer, and/or the like in order to implement, for example, at least one of frequency division duplex (FDD) or time division duplex (TDD). For example, a transmitting and receiving antenna, an amplifying unit, a transmitting and receiving unit, a transmission path interface, and the like may be implemented by the communication device 1004. The transmission and receiving unit may be implemented in such a way that the transmission unit and the reception unit are physically or logically separated from each other.

The input device 1005 is an input device (for example, a keyboard, a mouse, a microphone, a switch, a button, a sensor, and/or the like) that receives input from the outside. The output device 1006 is an output device (for example, a display, a speaker, a LED lamp, and/or the like) that performs output to the outside. The input device 1005 and the output device 1006 may be integrated with each other (for example, into a touch panel).

The processor 1001, the storage device 1002, and the like are connected by a bus 1007 for communicating information. The bus 1007 may be configured using a single bus, or may be configured using a different bus for each device.

The base station 10 and the terminal 20 may be configured to each include hardware such as a microprocessor, a digital signal processor (DSP), an application specific integrated circuit (ASIC), a programmable logic device (PLD), or a field programmable gate array (FPGA), and some or all of the functional blocks may be implemented by the hardware. For example, the processor 1001 may be implemented using at least one of these sets of hardware.

### (Summary of Embodiment)

As described above, according to the embodiment of the present invention, a terminal is provided which includes a reception unit configured to receive a configuration concerning semi-persistent scheduling (SPS) and a physical downlink shared channel (PDSCH) according to the SPS from a base station; a control unit configured to determine a hybrid automatic repeat request acknowledgement (HARQ-ACK) feedback information corresponding to the PDSCH according to the SPS, configure a HARQ-ACK codebook concerning the feedback information, and determine a bit with respect to the feedback information by applying the codebook; and a transmission unit configured to transmit the feedback information to the base station. The control unit is configured to configure the codebook based on the configuration concerning the SPS.

According to the above-described configuration, the terminal 20 can configure the HARQ-ACK codebook corresponding to partially disabled or skipped SPS-HARQ-ACK and transmit the HARQ-ACK feedback information to the base station 10. That is, the terminal having received data from the base station can transmit the feedback information corresponding to reception of the data to the base station.

In a case where the configuration concerning the SPS includes information indicating to disable HARQ-ACK feedback, the control unit need not be configured to include the bit with respect to HARQ-ACK feedback corresponding to the PDSCH in the codebook. With this configuration, the terminal 20 can configure the HARQ-ACK codebook corresponding to partially disabled or skipped SPS-HARQ-ACK and transmit the HARQ-ACK feedback information to the base station 10.

In a case where the configuration concerning the SPS includes information indicating to disable HARQ-ACK feedback, and in a case where downlink control information (DCI) for scheduling a dynamic PDSCH corresponding to the bit with respect to HARQ-ACK feedback corresponding to the PDSCH according to the SPS is not detected, the control unit need not be configured to include the bit with respect to the HARQ-ACK feedback corresponding to the PDSCH according to the SPS in the codebook. With this configuration, the terminal 20 can configure the HARQ-ACK codebook corresponding to partially disabled or skipped SPS-HARQ-ACK and transmit the HARQ-ACK feedback information to the base station 10.

In a case where the configuration concerning the SPS includes information indicating to disable the HARQ-ACK feedback, and in a case where DCI for scheduling a dynamic PDSCH corresponding to the bit with respect to HARQ-ACK feedback corresponding to the PDSCH according to the SPS is detected, the control unit may be configured to include a bit with respect to HARQ-ACK feedback corresponding to the dynamic PDSCH in the codebook. With this configuration, the terminal 20 can configure the HARQ-ACK codebook corresponding to partially disabled or skipped SPS-HARQ-ACK and transmit the HARQ-ACK feedback information to the base station 10.

According to the embodiment of the present invention, a base station is provided which includes a transmission unit configured to transmit a configuration concerning semi-persistent scheduling (SPS) and a physical downlink shared channel (PDSCH) according to the SPS to a terminal; a control unit configured to determine hybrid automatic repeat request acknowledgement (HARQ-ACK) feedback information corresponding to the PDSCH according to the SPS, configure a HARQ-ACK codebook corresponding to the feedback information, and determine a bit with respect to the feedback information by applying the codebook; and a reception unit configured to receive the feedback information from the terminal. The control unit is configured to configure the codebook based on the configuration concerning the SPS.

According to the above-described configuration, the terminal 20 can configure the HARQ-ACK codebook corresponding to partially disabled or skipped SPS-HARQ-ACK and transmit the HARQ-ACK feedback information to the base station 10. That is, the terminal having received data from the base station can transmit the feedback information corresponding to reception of the data to the base station.

In addition, according to the embodiment of the present invention, a communication method is provided which includes: receiving, by a terminal, from a base station, a configuration concerning semi-persistent scheduling (SPS) and a physical downlink shared channel (PDSCH) according to the SPS; determining, by the terminal, hybrid automatic repeat request acknowledgement (HARQ-ACK) feedback information corresponding to the PDSCH according to the SPS, configuring, by the terminal, a HARQ-ACK codebook concerning the feedback information, and determining, by the terminal, a bit with respect to the feedback information by applying the codebook; transmitting, by the terminal, the feedback information to the base station; and configuring, by the terminal, the codebook based on the configuration concerning the SPS.

According to the above-described configuration, the terminal 20 can configure the HARQ-ACK codebook corresponding to partially disabled or skipped SPS-HARQ-ACK, and transmit the HARQ-ACK feedback information to the base station 10. That is, the terminal having received data from the base station can transmit feedback information corresponding to reception of the data to the base station.

### (Supplementary Explanation of Embodiment)

Although the embodiment of the present invention has been described above, the disclosed invention is not limited to such an embodiment, and those skilled in the art will understand various variations, modifications, alterations, substitutions, and the like. Although the present invention has been described using specific numerical examples in order to facilitate understanding of the present invention, these numerical values are merely examples and any other appropriate values may be used unless otherwise specified. Segmentation into items in the above description is not essential to the present invention. Contents described in two or more items may be used in combination as necessary, and contents described in one item may be applied to contents described in another item (as long as there occurs no contradiction). The boundaries of the functional units or the processing units in the functional block diagrams do not necessarily correspond to the boundaries of the physical components. The operations of a plurality of functional units may be physically performed by one component, or the operation of one functional unit may be physically performed by a plurality of components. With regard to the processing procedures described in the embodiment, the sequences of processes may be changed as long as there occur no contradiction. For convenience of explaining the processing, the base station 10 and the terminal 20 have been described using functional block diagrams, but such apparatuses may be implemented by hardware, software, or a combinations thereof. Software executed by the processor included in the base station 10 according to the embodiment of the present invention and software executed by the processor included in the terminal 20 according to the embodiment of the present invention may be stored in any appropriate storage media such as random access memories (RAM), flash memories, read-only memories (ROM), EPROMs, EEPROMs, registers, hard disks (HDDs), removable disks, CD-ROMs, databases, servers, or the like.

The specific method of each indication of information is not limited to those of the respective modes and embodiments described in the present disclosure, and the indication may be implemented in other methods. For example, the indication of information may be performed by physical layer signaling (for example, downlink control information (DCI) and/or uplink control information (UCI)), higher layer signaling (for example, radio resource control (RRC) signaling, medium access control (MAC) signaling, broadcast information (a master information block (MIB) or a system information block (SIB)), another signal, or a combination thereof. RRC signaling may be referred to as an RRC message, and may be, for example, an RRC connection setup message, an RRC connection reconfiguration message, or the like.

The respective modes and embodiments described in the present disclosure may be applied to at least one of systems using long term evolution (LTE), LIE-Advanced (LTE-A), SUPER 3G, IMI-Advanced, a 4th generation mobile communication system (4G), a 5th generation mobile communication system (5G), future radio access (FRA), new radio (NR), W-CDMA (registered trademark), GSM (registered trademark), CDMA2000, ultra mobile broadband (UMB), IEEE 802.11 (Wi-Fi (registered trademark)), IEEE 802.16 (WiMAX (registered trademark)), IEEE 802.20, ultra-wideband (UWB), Bluetooth (registered trademark), another system employing an appropriate system, or a next-generation system extended based thereon. In addition, a combination of a plurality of systems (for example, a combination of 5G and at least one of LTE or LTE-A) may be used.

The sequences of processing procedures, sequences, flowcharts, and the like of the respective modes and embodiments described in the present specification may be changed as long as there occurs no contradiction. For example, the methods described in the present disclosure use examples of sequences to present the elements of the various steps and are not limited to the specific sequences presented herein.

The specific operations described in the present specification as being performed by the base station 10 may be performed by an upper node of the base station 10 in some cases. In a network including one or more network nodes including the base station 10, it is apparent that various operations performed for communication with the terminal 20 may be performed by at least one of the base station 10 or another network node (for example, but not limited to, an MME, an S-GW, or the like) other than the base station 10. Although a case where there is one network node other than the base station 10 has been exemplified above, the other network node may be a combination of a plurality of other network nodes (for example, a MME and a S-GW).

Information, a signal, or the like described in the present disclosure may be output from a higher layer (or a lower layer) to a lower layer (or a higher layer). The information, the signal, or the like described in the present disclosure may be input or output via a plurality of network nodes.

Input or output information or the like may be stored in a specific location (for example, a memory) or may be managed using a management table. The input or output information or the like may be overwritten, updated, or appended by other information. The output information or the like may be deleted. The input information or the like may be transmitted to another apparatus.

A determination in the present disclosure may be performed with a value (0 or 1) represented by one bit, may be performed with a Boolean value (true or false), or may be performed through comparison of numerical values (for example, comparison with a predetermined value).

Software shall be interpreted broadly to mean instructions, instruction set, code, code segment, program code, program, subprogram, software module, application, software application, software package, routine, subroutine, object, executable file, thread of execution, procedure, function, or the like, whether it is referred to as software, firmware, middleware, microcode, hardware description language, or another name.

Software, instructions, information, and the like may be transmitted or received over a transmission medium. For example, if the software is transmitted from a website, server, or other remote source using at least one of wired technology (coaxial cable, optical fiber cable, twisted pair, digital subscriber line (DSL), etc.) or wireless technology (infrared, microwave, etc.), the at least one of the wired technology or the wireless technology is included in the definitions of the transmission medium.

Information, signals, and the like described in the present disclosure may be expressed using any of a variety of different technologies. For example, data, instructions, commands, information, signals, bits, symbols, chips, and the like a reference to which may be made throughout the above description may be expressed by voltages, currents, electromagnetic waves, magnetic fields or particles, optical fields or particles, or any combinations thereof.

It should be noted that the terms described in the present disclosure and terms necessary for understanding the present disclosure may be replaced with other terms having the same or similar meanings. For example, at least one of a channel or a symbol may be a signal (signaling). The signal may be a message. Also, a component carrier (CC) may be referred to as a carrier frequency, a cell, a frequency carrier, or the like.

The terms “system” and “network” used in the present disclosure are used interchangeably.

The information, the parameters, and the like described in the present disclosure may be expressed by using absolute values, may be expressed by using relative values from predetermined values, or may be expressed by using other corresponding information. For example, a radio resource may be identified by an index.

The names used for the above-mentioned parameters are in no way limiting. Furthermore, equations and the like that use these parameters may differ from those explicitly disclosed in the present disclosure. Various channels (e.g., PUCCH, PDCCH, etc.) and information elements may be identified by any other suitable names, and thus the various names assigned to these various channels and information elements are in no way limiting.

In the present disclosure, terms such as “base station (BS)”, “radio base station”, “fixed station”, “NodeB”, “eNodeB (eNB)”, “gNodeB (gNB)”, “access point”, “transmission point”, “reception point”, “transmission/reception point”, “cell”, “sector”, “cell group”, “carrier”, “component carrier” and the like may be used interchangeably. A base station may also be referred to with a term such as a macro cell, a small cell, a femto cell, a pico cell, etc.

The base station can accommodate one or more (e.g., three) cells. When the base station accommodates multiple cells, the entire coverage area of the base station may be divided into multiple smaller areas, and each smaller area may also provide a communication service by a base station subsystem (for example, an indoor small base station (remote radio head (RRH)). The term “cell” or “sector” indicates part or all of the coverage area of at least one of the base station or the base station subsystem providing communication services in this coverage.

In the present disclosure, the teams “mobile station (MS),” “user terminal,” “user equipment (UE),” “terminal,” and the like may be used interchangeably.

The mobile station may also be referred to by the persons skilled in the art as a subscriber station, a mobile unit, a subscriber unit, a wireless unit, a remote unit, a mobile device, a wireless device, a wireless communication device, a remote device, a mobile subscriber station, an access terminal, a mobile terminal, a wireless terminal, a remote terminal, a handset, a user agent, a mobile client, a client, or another suitable term.

At least one of the base station or the mobile station may be referred to as a transmission device, a reception device, a communication device, or the like. Note that at least one of the base station or the mobile station may be a device mounted on a mobile body, may be a mobile body itself, or the like. The mobile body may be a vehicle (for example, a car, an airplane, or the like), a moving body that moves without an operator (for example, a drone, an automatic driving vehicle, or the like), or a robot (manned or unmanned). At least one of the base station or the mobile station may be a device that does not necessarily move during a communication operation. For example, at least one of the base station or the mobile station may be configured to communicate with an internet of things (IoT) device such as a sensor.

The base station in the present disclosure may be read as a user terminal. For example, each mode or the embodiment of the present disclosure may be applied to a configuration in which communication between the base station and the user terminal is replaced with communication between a plurality of terminals 20 (which type of communication may be referred to as D2D (Device-to-Device), V2X (Vehicle-to-Everything), or the like, for example). In this case, one of the terminals 20 may have the functions of the base station 10 described above. The terms such as “up” and “down” may be replaced with terms (for example, “side”) suitable to terminal-to-terminal communication. For example, each of an uplink channel, a downlink channel, and the like may be read as a side channel.

Similarly, the user terminal in the present disclosure may be read as a base station. In this case, the base station may be configured to have the functions of the above-described user terminal.

The term “determining” used in the present disclosure may mean a wide variety of actions. “Determining” may mean, for example, that it has been “determined” that judging, calculating, computing, processing, deriving, investigating, looking up, searching (e.g., searching in a table, a database, or another data structure), inquiring, or ascertaining has been performed. Also, “determining” may mean that it has been “determined” that receiving (e.g., receiving information), transmitting (e.g., transmitting information), inputting, outputting, accessing (e.g., accessing data in a memory) has been performed. In addition, “determining” may mean that it has been “determined” that resolving, selecting, choosing, establishing, comparing, or the like has been performed. That is, “determining” may mean that some action has been “determined”. In addition, “determining” may be replaced with “assuming”, “expecting”, “considering”, or the like.

The terms “connected” and “coupled” or any variation thereof mean any connection or coupling, either direct or indirect, between two or more elements, and may mean presence of one or more intermediate elements between the two elements that are “connected” or “coupled” to each other. Coupling or connecting between elements may be coupling or connecting between elements physically, logically, or a combination thereof. For example, “connecting” may be read as “accessing”. In the present disclosure, when either one of these terms is used, two elements may be considered as being “connected” or “coupled” to each other using one or more wires, cables, and/or printed electrical connections, as well as using any one of non-limiting and non-inclusive examples, such as electromagnetic energy having wavelengths in the radio frequency range, microwave range, or optical (either of both visible and invisible) range.

A reference signal may be abbreviated as RS, and may be referred to as a pilot depending on an applied standard.

The words “based on” used in the present disclosure do not mean “based only on” unless expressly specified otherwise. In other words, the words “based on” mean either one of both “based only on” and “based at least on”.

Any reference to an element using a modifying word such as “first,” “second,” or the like used in the present disclosure does not generally limit the quantities or sequence of those elements. These modifying words may be used in the present disclosure as a convenient method of distinguishing between two or more elements. Thus, a reference to first and second elements does not mean that only the two elements may be employed or that the first element must precede the second element in some manner.

“Means” in the configuration of each apparatus described above may be replaced with “unit”, “circuit”, “device”, or the like.

Where “include”, “including” and variations thereof are used in the present disclosure, these terms are intended to be inclusive in a manner similar to the term “comprising.” Furthermore, the team “or” used in the present disclosure is not intended to mean “exclusive OR”.

A radio frame may include one or more frames with respect to the time domain. With respect to the time domain, each frame of one or more frames may be referred to as a subframe. A subframe may further include one or more slots with respect to the time domain. A subframe may have a fixed length of time (e.g., 1 ms) that does not depend on the numerology.

The numerology may be a communication parameter applied to at least one of transmission or reception of a certain signal or channel. The numerology may mean, for example, at least one of a subcarrier spacing (SCS), a bandwidth, a symbol length, a cyclic prefix length, a transmission time interval (TTI), the number of symbols per TTI, a radio frame configuration, a specific filtering process performed by a transmitter-receiver with respect to the frequency domain, a specific windowing process performed by a transmitter-receiver with respect to the time domain, and the like.

A slot may include one or more symbols (orthogonal frequency division multiplexing (OFDM) symbols, single carrier frequency division multiple access (SC-FDMA) symbols, or the like) with respect to the time domain. A slot may be a time unit based on the numerology.

A slot may include a plurality of mini-slots. Each minislot may include one or more symbols with respect to the time domain. A minislot may be referred to as a subslot. A minislot may include a smaller number of symbols than a slot. A PDSCH (or PUSCH) transmitted in time unit larger than a minislot may be referred to as a PDSCH (or PUSCH) mapping type A. A PDSCH (or PUSCH) transmitted using a minislot may be referred to as a PDSCH (or PUSCH) mapping type B.

Each of a radio frame, a subframe, a slot, a minislot, and a symbol means a time unit for transmitting a signal. A radio frame, a subframe, a slot, a minislot, and a symbol may be respectively referred to as names different from those stated above.

For example, one subframe may be referred to as a transmission time interval (TTI), a plurality of consecutive subframes may be referred to as a TTI, or one slot or one minislot may be referred to as a TTI. That is, at least one of a subframe or a TTI may be a subframe (1 ms) in the existing LTE, may have a period shorter than 1 ms (for example, 1 to 13 symbols), or may have a period longer than 1 ms. Note that a unit for expressing a TTI may be referred to as a slot, a minislot, or the like instead of a subframe.

A TTI means, for example, a minimum time unit with respect to scheduling in wireless communication. For example, in an LTE system, a base station performs scheduling for allocating radio resources (a frequency bandwidth, transmission power, and the like that can be used by each terminal 20) to each terminal 20 in units of TTIs. Note that the definition of TTI is not limited to this.

A TTI may be a transmission time unit for a channel-coded data packet (transport block), a code block, a code word, or the like, or may be a processing unit of scheduling, link adaptation, or the like. When a TTI is given, a time interval (for example, the number of symbols) to which a transport block, a code block, a code word, or the like is actually mapped may be shorter than the TTI.

When one slot or one minislot is referred to as a TTI, one or more TTIs (i.e., one or more slots or one or more minislots) may be a minimum time unit of scheduling. The number of slots (the number of minislots) included in the minimum time unit of scheduling may be controlled.

A TTI having a time length of a 1 ms may be referred to as a normal TTI (a TTI in LTE Rel. 8-12), a long TTI, a normal subframe, a normal subframe, a long subframe, a slot, or the like. A TTI that is shorter than a normal TTI may be referred to as a shortened TTI, a short TTI, a partial or fractional TTI, a shortened subframe, a short subframe, a minislot, a subslot, a slot, etc.

Note that a long TTI (for example, a normal TTI, a subframe, or the like) may be read as a TTI having a time length exceeding 1 ms, and a short TTI (for example, a shortened TTI or the like) may be read as a TTI having a TTI length less than the TTI length of along TTI and equal to or greater than 1 ms.

A resource block (RB) is a resource allocation unit with respect to the time domain and the frequency domain, and may include one or more contiguous subcarriers with respect to the frequency domain. The number of subcarriers included in each RB may be the same regardless of the numerology, for example, 12. The number of subcarriers included in an RB may be determined based on the numerology.

An RB with respect to the time domain may include one or more symbols, and may have a length of one slot, one mini-slot, one subframe, or one TTI. Each of one TTI and one subframe may include one or a plurality of resource blocks.

Note that one or a plurality of RBs may be referred to as a physical resource block (PRB: Physical RB), a subcarrier group (SCG: Sub-Carrier Group), a resource element group (REG: Resource Element Group), a PRB pair, an RB pair, or the like.

A resource block may include one or a plurality of resource elements (REs). For example, one RE may have a radio resource region of one subcarrier and one symbol.

A bandwidth part (BWP) (which may also be referred to as a partial bandwidth, etc.) may mean a subset of contiguous common resource blocks (RBs) for the certain numerology in a certain carrier. The common RB may be identified by an RB index with respect to a common reference point of the carrier. A PRB may be defined using a certain BWP and may be numbered in the BWP.

A BWP may mean a BWP for UL (UL BWP) and may mean a BWP for DL (DL BWP). For the terminal 20, one or more BWPs may be configured for one carrier.

At least one of configured BWPs may be active and the terminal 20 need not be assumed to transmit and receive certain signals/channels outside the active BWP. Each of “cell”, “carrier”, and the like in the present disclosure may be read as “BWP”.

The above-described structures of the radio frame, the subframe, the slot, the minislot, and the symbol are merely examples. For example, configurations such as the number of subframes included in a radio frame, the number of slots per subframe or radio frame, the number of minislots included in a slot, the number of symbols and RBs included in a slot or minislot, the number of subcarriers included in an RB, the number of symbols in a TTI, a symbol length, a cyclic prefix (CP) length, and the like can be changed in various ways.

In the present disclosure, for example, when articles such as a, an, and the in English are added by language translation, each of nouns following these articles may be of a plural form in the present disclosure.

In the present disclosure, the expression that “A and B are different” may mean “A and B are different from each other”. It should be noted that the expression may that “A and B are different” also mean that “A and B are each different from C”. Each of the term “separating”, “coupling”, and the like may also be interpreted in the same way as the term “different”.

The respective modes or embodiments described in the present disclosure may be used alone, may be used in combination, or may be switched thereamong depending on each particular application. Indication of certain information (for example, indication that “it is X”) is not limited to being performed explicitly, and may be performed implicitly (for example, by not performing indication of certain information).

Although the present disclosure has been described in detail above, it is clear to those skilled in the art that the present disclosure is not limited to the embodiments described in the present disclosure. The present disclosure can be implemented in a mode having been modified or changed without departing from the scope of the present disclosure defined by the description of the claims. Accordingly, the description of the present disclosure is for illustrative purposes and is not meant to be in any way limiting to the present disclosure.

### DESCRIPTION OF SYMBOLS

10 Base station
110 Transmission unit
120 Reception unit
130 Configuration unit
140 Control unit
20 Terminal
210 Transmission unit
220 Reception unit
230 Configuration unit
240 Control unit
1001 Processor
1002 Storage device
1003 Auxiliary storage device
1004 Communication device
1005 Input device
1006 Output device

1. A terminal comprising:
a reception unit configured to receive a configuration concerning semi-persistent scheduling (SPS) and a physical downlink shared channel (PDSCH) according to the SPS from a base station; and
a control unit configured to determine hybrid automatic repeat request acknowledgement (HARQ-ACK) feedback information corresponding to the PDSCH according to the SPS, configure a HARQ-ACK codebook concerning the feedback information, and determine a bit with respect to the feedback information by applying the codebook; and
a transmission unit configured to transmit the feedback information to the base station,
wherein
the control unit is configured to configure the codebook based on the configuration concerning the SPS.

2. The terminal as claimed in claim 1,
wherein
the control unit is configured not to include the bit with respect to HARQ-ACK feedback corresponding to the PDSCH according to the SPS in the codebook in a case where the configuration concerning the SPS includes information indicating to disable HARQ-ACK feedback.

3. The terminal as claimed in claim 1,
wherein
in a case where the configuration concerning the SPS includes information indicating to disable HARQ-ACK feedback, and in a case where downlink control information (DCI) for scheduling a dynamic PDSCH corresponding to the bit with respect to HARQ-ACK feedback corresponding to the PDSCH according to the SPS is not detected, the control unit is configured not to include in the codebook the bit with respect to HARQ-ACK feedback corresponding to the PDSCH according to the SPS.

4. The terminal as claimed in claim 1,
wherein
in a case where the configuration concerning the SPS includes information indicating to disable HARQ-ACK feedback, and in a case where DCI for scheduling a dynamic PDSCH corresponding to the bit with respect to HARQ-ACK feedback corresponding to the PDSCH according to the SPS is detected, the control unit is configured to include in the codebook a bit with respect to HARQ-ACK feedback corresponding to the dynamic PDSCH.

5. A base station comprising:
a transmission unit configured to transmit a configuration concerning semi-persistent scheduling (SPS) and a physical downlink shared channel (PDSCH) according to the SPS to a terminal;
a control unit configured to determine hybrid automatic repeat request acknowledgement (HARQ-ACK) feedback information corresponding to the PDSCH according to the SPS, configure a HARQ-ACK codebook concerning the feedback information, and determine a bit with respect to the feedback information by applying the codebook; and
a reception unit configured to receive the feedback information from the terminal,
wherein
the control unit is configured to configure the codebook based on the configuration concerning the SPS.

6. A communication method comprising:
receiving, by a terminal, from a base station, a configuration concerning semi-persistent scheduling (SPS) and a physical downlink shared channel (PDSCH) according to the SPS;
determining, by the terminal, hybrid automatic repeat request acknowledgement (HARQ-ACK) feedback information corresponding to the PDSCH according to the SPS, configuring, by the terminal, a HARQ-ACK codebook concerning the feedback information, and determining, by the terminal, a bit with respect to the feedback information by applying the codebook;
transmitting, by the terminal, the feedback information to the base station; and
configuring, by the terminal, the codebook based on the configuration concerning the SPS.
